(19) United States
(12) Patent Application Publication
(10) Pub. No.: US 2013/0249693 A1
(43) Pub. Date: Sep. 26, 2013

(54) Rodent Deterrent Apparatus

(71) Applicants: Charles A. Neal, Cave Creek, AZ (US); Mickey Perreaud, Cave Creek, AZ (US); Renee Yvonne Waldman, Cave Creek, AZ (US)

(72) Inventors: Charles A. Neal, Cave Creek, AZ (US); Mickey Perreaud, Cave Creek, AZ (US); Renee Yvonne Waldman, Cave Creek, AZ (US)

(21) Appl. No.: 13/740,559

(22) Filed: Jan. 14, 2013

Related U.S. Application Data
(60) Provisional application No. 61/615,208, filed on Mar. 24, 2012.

(51) Int. Cl. A01M 29/00

(52) U.S. Cl. CPC A01M 29/00
USPC 340/573.2

(57) ABSTRACT

The present invention generally relates to rodent deterrent apparatus. Specifically, this invention relates to an apparatus that is easily attachable to one or more surfaces in an area where rodents frequently nest unwantedly and works to deter the rodents from nesting in those areas.

### CROSS REFERENCE TO RELATED APPLICATIONS

This application claims the benefit of U.S. Provisional Patent Application No. 61/615,208 filed Mar. 24, 2012, the entire disclosure of which is incorporated herein by reference.

### FIELD OF THE INVENTION

The present invention generally relates to a rodent deterrent apparatus. Specifically, this invention relates to an apparatus that is easily attachable to one or more surfaces in an area where rodents frequently nest unwantedly and works to deter the rodents from nesting in those areas.

### BACKGROUND OF INVENTION

The presence of rodents and other pests is a concern of property owners everywhere. More specifically, rodents and other pests can carry and spread disease and other unwanted filth that is undesirable. To deal with this issue, a number of systems and methods currently exist, including poisons, repellents, and traps. The currently available solutions, however, do have drawbacks. First, many of the methods are lethal, killing the rodent or other pest. This can have detrimental effects on the local ecosystem by exposing other animals to the poisons and traps or by reducing the food supply for the animals that prey on the rodents and other pests. Additionally, currently available pest solutions are primarily intended for temporary placement and/or disposable use, which is not an optimal use of resources.

Therefore, there is a need in the art for rodent deterrent apparatus that helps prevent rodent and pest activity in a non-lethal manner and is durable for repeated use and/or permanent placement. These and other features and advantages of the present invention will be explained and will become obvious to one skilled in the art through the summary of the invention that follows.

### SUMMARY OF INVENTION

Accordingly, it is an object of the present invention to provide an apparatus for curtailing rodent activity whereby a deterring means on the apparatus deters rodent nesting and associated activities.

According to an embodiment of the present invention, a rodent deterrent apparatus including a deterrent apparatus controller, including one or more deterrent means, a control element, and a power source, wherein the power source is configured to provide power to the one or more deterrent means and the control element, wherein the control element is configured to selectively activate the one more deterrent means, and a main housing, wherein the main housing is configured to retain the deterrent apparatus controller.

According to an embodiment of the present invention, the rodent deterrent apparatus further includes one or more attachment means.

According to an embodiment of the present invention, the one or more attachment is comprised of a group of attachment means including magnets, adhesives, hook-and-loop fasters, and clips.

According to an embodiment of the present invention, the one or more deterrent means are selected from a group including a light source, an audio source, and an ultrasonic source.

According to an embodiment of the present invention, the light source is a light-emitting diode (LED) light.

According to an embodiment of the present invention, the power source is a battery.

According to an embodiment of the present invention, the power source is an alternating current (AC) adapter.

According to an embodiment of the present invention, the power source is a direct current (DC) adapter.

According to an embodiment of the present invention, the power source is a photovoltaic panel.

According to an embodiment of the present invention, the deterrent apparatus controller further includes an accelerometer.

According to an embodiment of the present invention, the main housing is comprised of a water and shock resistant material suitable for outdoor use.

According to an embodiment of the present invention, the main housing is sealed to protect the deterrent apparatus controller from external elements.

According to an embodiment of the present invention, the rodent deterrent apparatus further includes a sensor operably connected to the control element, wherein the sensor is configured to detect rodents and upon sensing a rodent sends a signal to the control element, wherein the signal causes the control element to engage one or more of the one or more deterrent means.

According to an embodiment of the present invention, the sensor is a motion sensor.

According to an embodiment of the present invention, the control element is a printed circuit board.

According to an embodiment of the present invention, the rodent deterrent apparatus further includes a status indicator operably connected to the control element, wherein the status indicator is configured to convey information about one or more components of the rodent deterrent apparatus.

### BRIEF DESCRIPTION OF THE DRAWINGS

FIG. 1 is a perspective view of a rodent deterrent apparatus, in accordance with an embodiment of the present invention;

FIG. 2 is a side view of a rodent deterrent apparatus, in accordance with an embodiment of the present invention;

FIG. 3 is a top view of a rodent deterrent apparatus, in accordance with an embodiment of the present invention;

FIG. 4 is a top view of a rodent deterrent apparatus, in accordance with an embodiment of the present invention;

FIG. 5 is a bottom view of a rodent deterrent apparatus, in accordance with an embodiment of the present invention;

FIG. 6 is a perspective view of a rodent deterrent apparatus, in accordance with an embodiment of the present invention;

FIG. 7 is a side view of a rodent deterrent apparatus, in accordance with an embodiment of the present invention;

FIG. 8 is a top view of a rodent deterrent apparatus, in accordance with an embodiment of the present invention;

FIG. 9 is a bottom view of a rodent deterrent apparatus, in accordance with an embodiment of the present invention; and

FIG. 10 is a front view of a power source for a rodent deterrent apparatus, in accordance with an embodiment of the present invention.

FIG. 11 is a schematic overview of a rodent deterrent apparatus with optional components, in accordance with an exemplary embodiment on the present invention.

### DETAILED SPECIFICATION

The present invention generally relates to rodent deterrent apparatus. Specifically, this invention relates to an apparatus that is easily attachable to one or more surfaces in an area where rodents frequently nest unwantedly and works to deter the rodents from nesting in those areas. In general, the apparatus is comprised of a main housing, an attachment means, a power source and a deterrent means.

According to an embodiment of the present invention, the rodent deterrent apparatus is comprised of deterrent apparatus controller and a main housing. Optionally, the rodent deterrent apparatus may include additional components, including, but not limited to an attachment means, a sensor, a status indicator, or any combination thereof. One of ordinary skill in the art would appreciate that there are numerous components that could be included with the present invention, and embodiments of the present invention are contemplated for use with any such sensor.

According to an embodiment of the present invention, the rodent deterrent apparatus is comprised of deterrent apparatus controller. In a preferred embodiment, the deterrent apparatus controller is comprised of a deterrent means, a control element, and a power source. In an alternate embodiment, the deterrent apparatus controller may further include an accelerometer. One of ordinary skill in the art would appreciate that the deterrent apparatus controller could be configured with additional components, and embodiments of the present invention are contemplated for use with any such components.

According to an embodiment of the present invention, the deterrent apparatus controller is comprised of one or more deterrent means. Deterrent means include, but are not limited to, light sources, audio sources, ultrasonic sources or any combination thereof. In a preferred embodiment, the deterrent means is a delayed strobe light with a delay between 1 and 5 seconds between pulses. The strobe light may be a small light emitting diode (LED) light or other similar strobe light with low power requirements to allow for extended use and minimal power drain on the power source. One of ordinary skill in the art would appreciate that there are numerous other types of light sources and delays that could be utilized with embodiments of the present invention, and embodiments of the present invention are contemplated for use with any type of light source and delay. Further, one of ordinary skill in the art would appreciate there are numerous types of deterrent means that could be utilized with embodiments of the present invention, and embodiments of the present invention are contemplated for use with any type of deterrent means.

According to an embodiment of the present invention, the deterrent apparatus controller is comprised of a control element. In a preferred embodiment, the control element is a printed circuit board (PCB). One of ordinary skill in the art would appreciate that there are control elements that could be utilized with embodiments of the present invention, and embodiments of the present invention are contemplated for use with any type of control element.

According to an embodiment of the present invention, the control element is a logic control that coordinates the functions of the other components of the deterrent apparatus controller. In the preferred embodiment, the control element regulates the interaction of the deterrent means and the power source to selectively activate the deterrent means. The control element activates the deterrent means by allowing the deterrent means to receive power from the power source. Alternatively the control element deactivates the deterrent means by blocking the deterrent means from the power source. In the preferred embodiment, the control element may be programmed to activate and deactivate the deterrent means according to a programmed timer or delay. Alternatively, the control element may be programmed to respond to input from a sensor to activate and deactivate the deterrent means. One of ordinary skill in the art would appreciate that the control element could regulate any number of components, and embodiments of the present invention are contemplated for use with any such component. Further, one of ordinary skill in the art would appreciate the control element could be governed by a variety of programs and inputs, and embodiments of the present invention are contemplated for use with any such program or input.

According to an embodiment of the present invention, the deterrent apparatus controller is comprised of a power source. The power source is configured to provide power to the control elements, deterrent means and other elements of the apparatus that may require power in order to function. The power source may be, for instance, alligator clips configured to be attached to a battery (e.g., vehicle battery), one or more batteries, an AC adapter, a DC adapter, a renewable power source (e.g., wind turbine, solar panel). One of ordinary skill in the art would appreciate that there are numerous power sources that may be utilized with embodiments of the present invention, and embodiments of the present invention are contemplated for use with any power source.

According to an embodiment of the present invention, the deterrent apparatus controller is comprised of an accelerometer. In a preferred embodiment, the accelerometer detects when the rodent deterrent apparatus is in motion, such as when the apparatus is attached to a vehicle, so that the entire rodent deterrent apparatus can be powered off to reduce drain on the power source. One of ordinary skill in the art would appreciate that there are numerous accelerometers that may be utilized with embodiments of the present invention, and embodiments of the present invention are contemplated for use with any accelerometer.

According to an embodiment of the present invention, the main housing of the rodent deterrent apparatus is configured to house and protect the deterrent apparatus controller and other components of the rodent deterrent apparatus. In a preferred embodiment, the main housing is comprised of a weather resistant and shock resistant material appropriate for use in outdoor environments. For instance, the main housing may be comprised of a durable plastic material which is both water and shock resistant. One of ordinary skill in the art would appreciate that there are numerous materials from which the main housing could be constructed, and embodiments of the present invention are contemplated for use with main housings constructed from any material.

In certain embodiments, the main housing may be sealed in a manner to protect the components housed therein from external elements including, but not limited to, water, ice, snow, dirt and other corrosive materials. For instance, the housing may be formed from two pieces (a top piece and a bottom piece) with the two pieces being sealed together with an O-ring or other flexible sealing membrane. In embodiments where certain components (e.g., power source components, deterrent components) extend to a location exterior to the main housing, those channels or through-holes may be sealed as well by similar means. One of ordinary skill in the art would appreciate there are numerous ways to provide sealing of a housing, and embodiments of the present invention are contemplated for use with any method for sealing a housing.

According to an embodiment of the present invention, the rodent deterrent apparatus is comprised of an attachment means. While this element may be optional, preferred embodiments of the present invention are comprised of an attachment means that secures to a side (i.e., rear, bottom, side, front, and top) of the apparatus and is configured to secure the entire apparatus to a surface of the area to be protected by the apparatus. Attachment means include, but are not limited to, magnets, adhesives, epoxies, Velcro attachments, zip ties and clips. One of ordinary skill in the art would appreciate that there are numerous attachment means that may be utilized with embodiments of the present invention, and embodiments of the present invention are contemplated for use with any attachment means.

According to an embodiment of the present invention, the rodent deterrent apparatus is comprised of a sensor. In a preferred embodiment, the sensor is a motion sensor that is operably connected to the control element of the deterrent apparatus controller. The motion sensor would allow the rodent deterrent apparatus to sense the presence of rodent and signal the control element to activate the deterrent means. One of ordinary skill in the art would appreciate that there are numerous sensors that may be utilized with embodiments of the present invention, and embodiments of the present invention are contemplated for use with any such sensor.

According to an embodiment of the present invention, the rodent deterrent apparatus is comprised of a status indicator. In a preferred embodiment the status indicator is operably connected to the control element of the deterrent apparatus controller and signals the operational status of rodent deterrent apparatus or its components. As an illustrative example, the status indicator could indicate the power level of a battery or other power source. In an alternative example, the status indicator could indicate the function of an ultrasonic deterrent means that would otherwise be inaudible to a person. In a final example, that status indicator could be useful to convey information about the functionality of the rodent deterrent apparatus when the apparatus is mounted in location that is difficult to access. One of ordinary skill in the art would appreciate that there are numerous functions that may be performed by a status indicator, and embodiments of the present invention are contemplated for use with any such function.

Embodiments of the present invention are configured for use in a multitude of locations. Appropriate and useful locations include, inside the engine compartment or other area of a vehicle (e.g., car, truck, watercraft, boat, trailer, recreational vehicle), inside a barbeque grill or other outdoor cooking area frequented by rodents, under decks, under gazebos or anywhere else rodents frequently choose to nest. One of ordinary skill in the art would appreciate that there are numerous locations where the apparatus could be utilized, and embodiments of the present invention are contemplated for use in any location.

### EXEMPLARY EMBODIMENTS

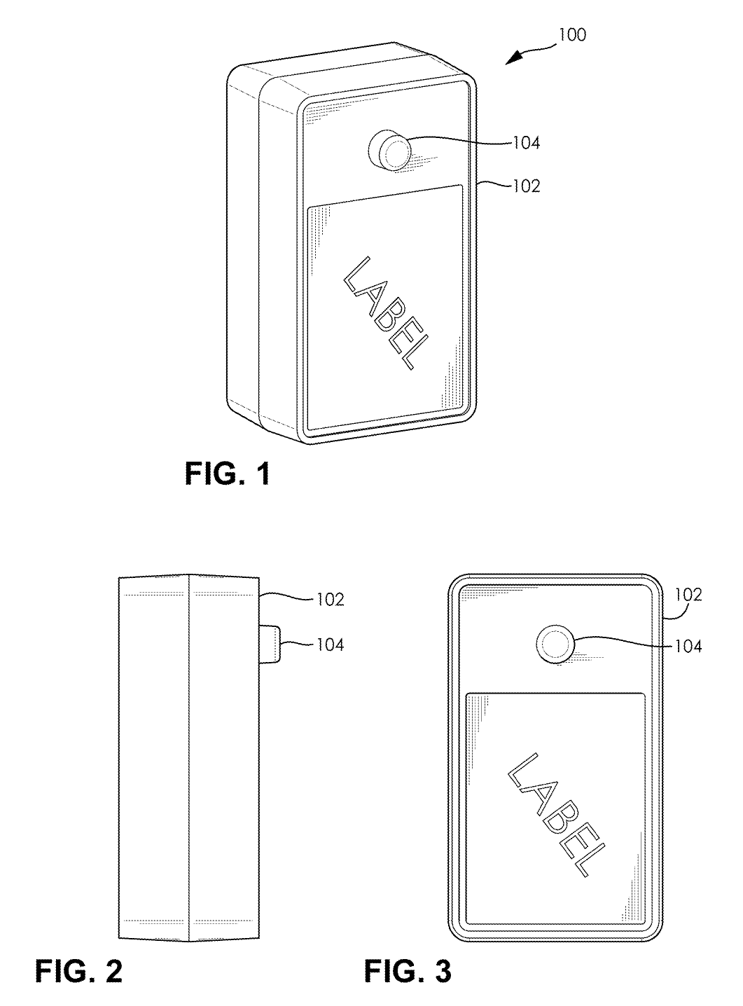

Turning now to FIG. 1, a perspective view of a rodent deterrent apparatus 100, in accordance with an embodiment of the present invention. In a preferred embodiment, the rodent deterrent apparatus is primarily comprised of a main housing 102 and deterrent means 104. In this embodiment, a rectangular main housing 102 is utilized with a deterrent means 104 comprised of a LED light which blinks on a 1-5 second delay. The power source of this embodiment is contained within the main housing 102 and the entire main housing 102 is sealed and protected from external elements.

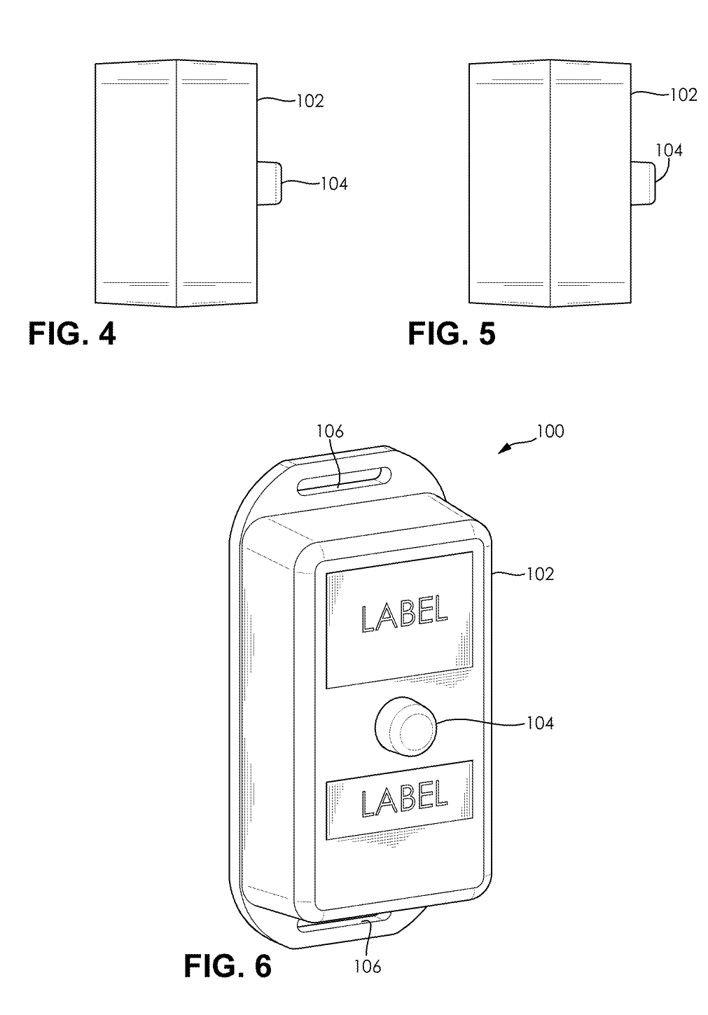

Turning now to FIGS. 2-5, an exemplary embodiment of the present invention is shown. FIG. 2 is a side view of a rodent deterrent apparatus, in accordance with an embodiment of the present invention. FIG. 3 is a top view of a rodent deterrent apparatus, in accordance with an embodiment of the present invention. FIG. 4 is a front view of a rodent deterrent apparatus, in accordance with an embodiment of the present invention. FIG. 5 is a rear view of a rodent deterrent apparatus, in accordance with an embodiment of the present invention. In this embodiment, a rectangular main housing 102 is utilized with a deterrent means 104 comprised of a LED light which blinks on a 1-5 second delay. The power source of this embodiment is contained within the main housing 102 and the entire main housing 102 is sealed and protected from external elements.

Uses for the above described embodiment include installation in outdoor barbeque units to discourage pack rats and other rodents/vermin from building nests, rummaging through or otherwise visiting barbeque units. The low voltage LED (deterrent means) provides low battery drain, allowing for the internal battery source to last for extended periods of time, making it convenient as replacing or recharging the power source can be done very infrequently.

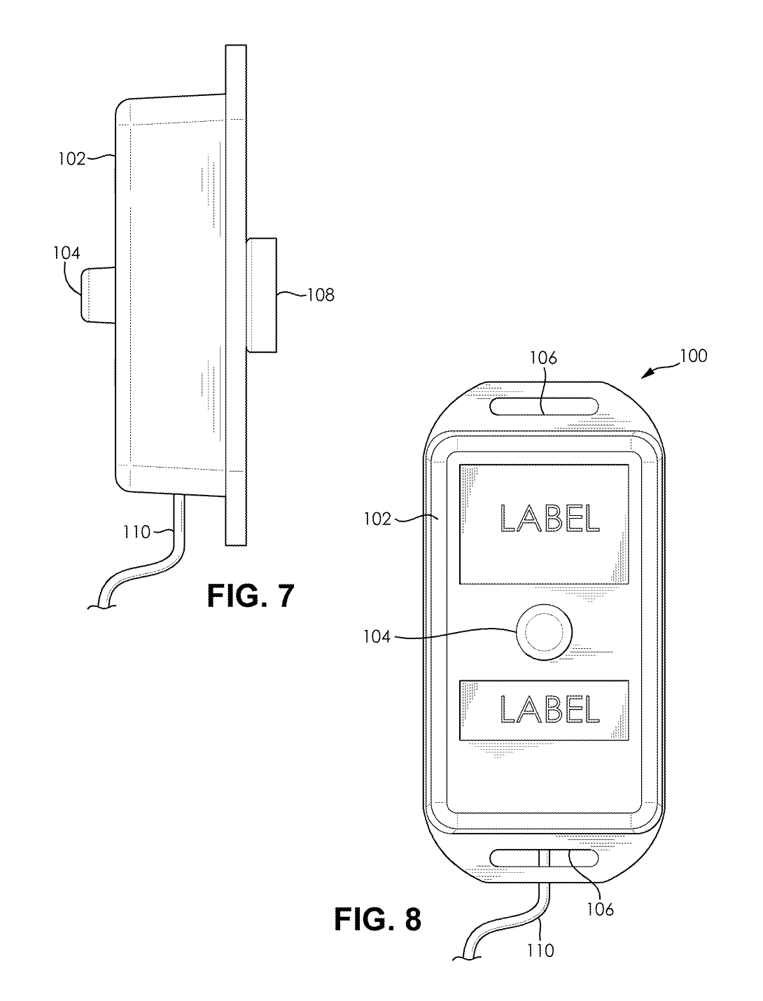

Turning now to FIG. 6, a perspective view of a rodent deterrent apparatus 100, in accordance with an embodiment of the present invention. In a preferred embodiment, the rodent deterrent apparatus is primarily comprised of a main housing 102, deterrent means 104, and a first attachment means 106. In this embodiment, a rectangular main housing 102 is utilized with a deterrent means 104 comprised of a LED light which blinks on a 1-5 second delay. The power source of this embodiment is contained within the main housing 102 and the entire main housing 102 is sealed and protected from external elements. In this embodiment, the main housing 102 further includes a first attachment means 106, which may be used to attach the rodent deterrent apparatus 100 to another object. The first attachment means 106 can be used to attach the rodent deterrent apparatus 100 with a variety of securing means, including, but not limited to, screws, bolts, nails, rivets, zip-ties, or any combination thereof.

Turning now to FIG. 7, a side view of a rodent deterrent apparatus, in accordance with an embodiment of the present invention. In a preferred embodiment, the rodent deterrent apparatus is primarily comprised of a main housing 102, deterrent means 104, a second attachment means 108, and a power source 110. In this embodiment, a rectangular main housing 102 is utilized with a deterrent means 104 comprised of a LED light which blinks on a 1-5 second delay. The power source 110 of this embodiment is external to the main housing 102 and might include a battery, an AC adapter, a DC adapter, a photovoltaic panel, or any combination thereof. The entire main housing 102 is sealed and protected from external elements. In this embodiment, the main housing 102 further includes a second attachment means 108, which in this embodiment is a magnet, but may also include, but is not limited to, a clip mechanism or snapping means.

Turning now to FIG. 8, a top view of a rodent deterrent apparatus 100, in accordance with an embodiment of the present invention. In a preferred embodiment, the rodent deterrent apparatus is primarily comprised of a main housing 102, deterrent means 104, a first attachment means 106, and a power source 110. In this embodiment, a rectangular main housing 102 is utilized with a deterrent means 104 comprised of a LED light which blinks on a 1-5 second delay. The power source 110 of this embodiment is external to the main housing 102 and might include, but is not limited to, a battery, an AC adapter, a DC adapter, a photovoltaic panel, or any combination thereof. In this embodiment, the main housing 102 further includes a first attachment means 106, which may be used to attach the rodent deterrent apparatus 100 to another object. The first attachment means 106 can be used to attach the rodent deterrent apparatus 100 with a variety of securing means, including, but not limited to, screws, bolts, nails, rivets, zip-ties, or any combination thereof.

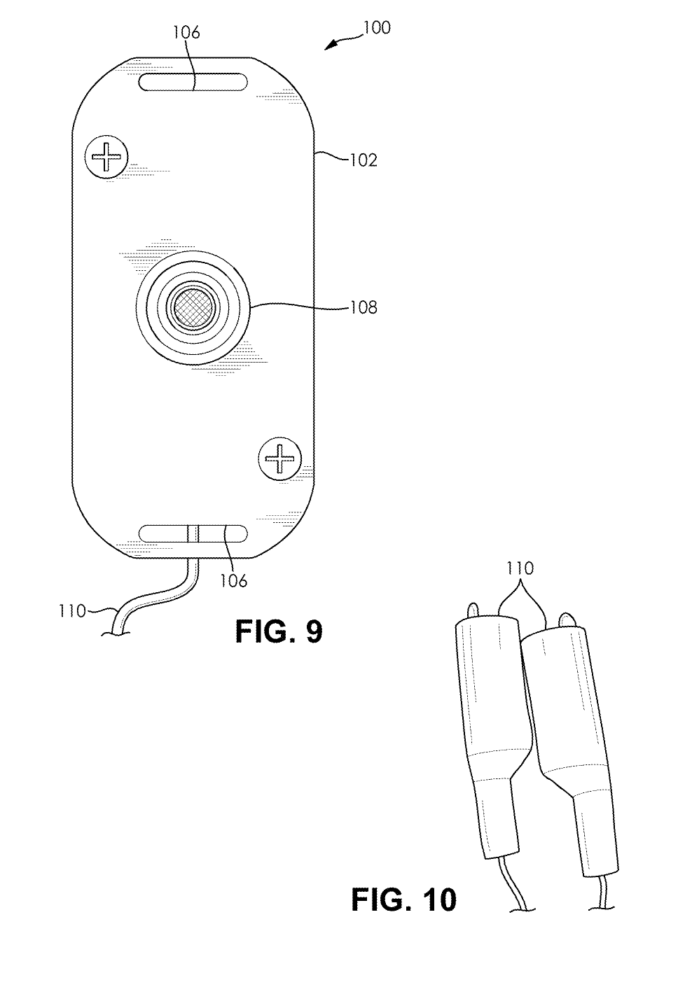

Turning now to FIG. 9, a bottom view of a rodent deterrent apparatus 100, in accordance with an embodiment of the present invention. In a preferred embodiment, the rodent deterrent apparatus is primarily comprised of a main housing 102, a first attachment means 106, a second attachment means 108, and a power source 110. The entire main housing 102 is sealed and protected from external elements. In this embodiment, the main housing 102 includes a first attachment means 106, which may be used to attach the rodent deterrent apparatus 100 to another object. The first attachment means 106 can be used to attach the rodent deterrent apparatus 100 with a variety of securing means, including, but not limited to, screws, bolts, nails, rivets, zip-ties, or any combination thereof. This embodiment of the rodent deterrent apparatus 100 further includes a second attachment means 108, which in this embodiment is a magnet, but may also include, but is not limited to, a clip mechanism or snapping means. The power source 110 of this embodiment is external to the main housing 102 and might include a battery, an AC adapter, a DC adapter, a photovoltaic panel, or any combination thereof.

Turning now to FIG. 10, a front view of a power source 110 for a rodent deterrent apparatus, in accordance with an embodiment of the present invention. In this embodiment, the power source is a set of alligator clips configured to be attached to a battery or other electrical source.

Uses for the above described embodiment include installation in the engine compartment of a vehicle. The LED light is designed to discourage pack rats and other rodents/vermin from building nests, rummaging through or otherwise visiting the engine compartment of a vehicle. The low voltage LED (deterrent means) provides low battery drain, allowing the power source to be clipped to a battery of the vehicle and provide long lasting use for the apparatus, especially when the vehicle is used, even infrequently, and allowed to have the alternator of the vehicle recharge the battery to which the power source is attached. In this manner, the apparatus can allow nearly perpetual usage without replacement.

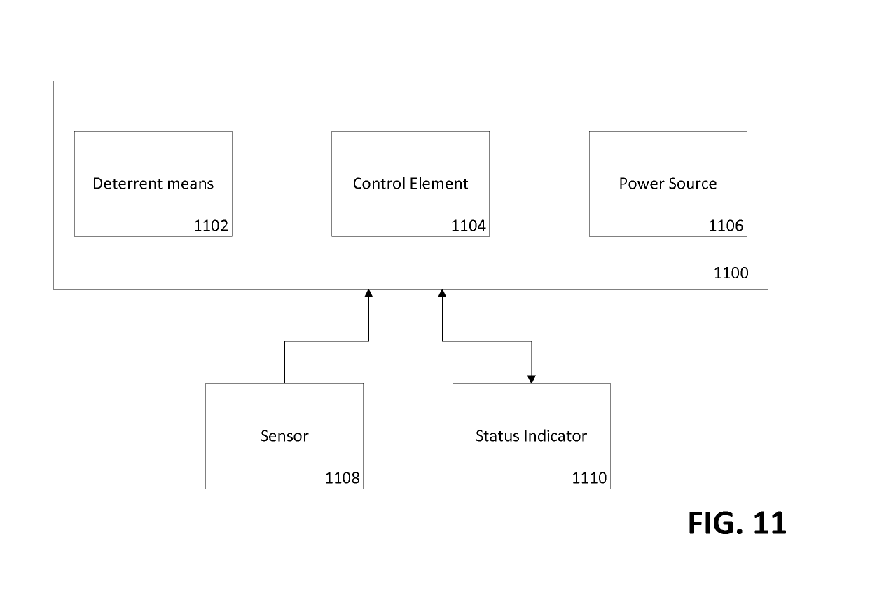

Turning now to FIG. 11, a schematic overview of a rodent deterrent apparatus with optional components, in accordance with an exemplary embodiment of the present invention is shown. In this embodiment, the rodent deterrent apparatus is comprised of a deterrent apparatus controller 1100 and the optional components of a sensor 1108 and a status indicator 1110. The deterrent apparatus controller 1100 is further comprised of a deterrent means 1102, a control element 1104, and a power source 1106.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A rodent deterrent apparatus, said apparatus comprising of:
a deterrent apparatus controller, comprising one or more deterrent means, a control element, and a power source,
wherein said power source is configured to provide power to said one or more deterrent means and said control element,
wherein said control element is configured to selectively activate said one more deterrent means; and
a main housing, wherein said main housing is configured to retain said deterrent apparatus controller.

2. The rodent deterrent apparatus of claim 1, wherein said rodent deterrent apparatus further comprises one or more attachment means attached to said main housing.

3. The rodent deterrent apparatus of claim 2, wherein said one or more attachment means are selected from a group of attachment means comprising magnets, adhesives, hook-and-loop fasters, and clips.

4. The rodent deterrent apparatus of claim 1, wherein said one or more deterrent means are selected from a group comprising a light source, an audio source, and an ultrasonic source.

5. The rodent deterrent apparatus of claim 4, wherein said light source is a light-emitting diode (LED) light.

6. The rodent deterrent apparatus of claim 1, wherein said power source is a battery.

7. The rodent deterrent apparatus of claim 1, wherein said power source is an alternating current (AC) adapter.

8. The rodent deterrent apparatus of claim 1, wherein said power source is a direct current (DC) adapter.

9. The rodent deterrent apparatus of claim 1, wherein said power source is a photovoltaic panel.

10. The rodent deterrent apparatus of claim 1, wherein said deterrent apparatus controller further comprises an accelerometer.

11. The rodent deterrent apparatus of claim 1, wherein said main housing is comprised of a water and shock resistant material suitable for outdoor use.

12. The rodent deterrent apparatus of claim 1, wherein said main housing is sealed to protect said deterrent apparatus controller from external elements.

13. The rodent deterrent apparatus of claim 1, further comprising a sensor operably connected to said control element, wherein said sensor is configured to detect rodents and upon sensing a rodent sends a signal to said control element, wherein said signal causes the control element to engage one or more of said one or more deterrent means.

14. The rodent deterrent apparatus of claim 13, wherein said sensor is a motion sensor.

15. The rodent deterrent apparatus of claim 1, wherein said control element is a printed circuit board.

16. The rodent deterrent apparatus of claim 1, further comprising a status indicator operably connected to said control element, wherein said status indicator is configured to convey information about one or more components of said rodent deterrent apparatus.
